(19) United States
(12) Patent Application Publication
(10) Pub. No.: US 2010/0170242 A1
(43) Pub. Date: Jul. 8, 2010

(54) Drive energy through buoyancy-gravitational force

(76) Inventor: Hartwig Irps, Vechelde (DE)

Correspondence Address: Hartwig IRPS, Beckmannstr.9, Vechelde, 38159, DE

(21) Appl. No.: 12/654,348

(22) Filed: Dec. 17, 2009

(30) Foreign Application Priority Data
Jan. 3, 2009 (DE) DE 102009003909.0

(51) Int. Cl. F03B 13/00

(52) U.S. Cl. 60/497

(57) ABSTRACT

Buoyancy forces [N] and gravitational forces [N] of buoys in fluids are used as drive forces. Buoys are placed in one or more water-filled container/s. To use the buoyancy force [N], the buoys are connected to an energy storage device, herein springs. In addition, the buoys are temporarily connected to a reference system by either the container or a movable frame within the container. Upon fastening the containers to a movable system, both buoyancy and gravitational forces [N] are exerted via a short working stroke, producing effective energy. To repeat said energy supply, the movable system must resume the starting position. For this process to occur, internal and external energy may be used. In a technical application, this invention can supply electric energy via a gyrating mass, propel hydraulic or compressed air cylinders, or enable other repetitive motions (pumps.) The described system can also be used for energy storage.

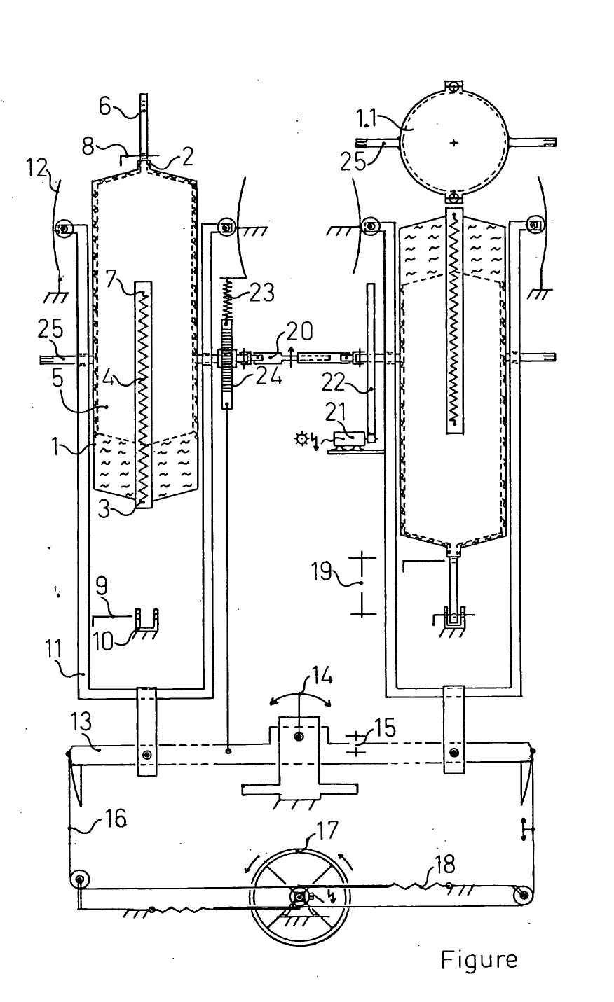

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

The Archimedes Principle describes the upwardly directed buoyancy of bodies in fluids and gases. A prerequisite for buoyancy is for the buoyancy medium to be able to reach underneath the buoyant body. The invention described herein requires fluid, typically water, as the buoyancy medium. Antifreeze can be added for sub-zero conditions.

The patent literature describes a “Water Motor” in U.S. Pat. No. 2,239,064 and a “Auftriebsmaschine/Buoyancy Engine” in DE 197 34 812 A1. Both suggested mechanisms vary fundamentally from the drive described in the following.

The task for this invention was to develop simple mechanisms to use the buoyancy force [N] and the gravitational force [N] of bodies, herein referred to as buoys, as driving forces. The system control requires external energy, ideally from renewable sources. [N=Newton]

### BRIEF SUMMARY OF THE INVENTION

In the present invention, buoyancy forces [N] and gravitational forces [N] of buoys in fluids (water) are used as drive forces. In a first aspect of the present invention, buoys are placed in one or more water-filled container/s. In order to utilize the buoyancy force [N], the buoys are connected to an energy storage device, springs in this case. In another feature of the present invention, the buoys are temporarily connected to a reference system by either the container or a movable frame within the container. Upon fastening the containers to a movable system, both the buoyancy and gravitational forces [N] are exerted via a working stroke and produce effective energy. In order to enable a repeat of said energy supply, the movable system must resume the starting position. For this process to occur, internal and external energy may be used; the latter ideally from renewable sources. Great forces are supplied via a short working stroke. External energy sources may include manual power, solar electricity, water power, tidal current, wind power, and other energy sources. In a technical application, the present invention can supply electric energy via a gyrating mass, propel hydraulic or compressed air cylinders, or enable other repetitive motions (pumps.) The herein described installation can also be used for energy storage.

### BRIEF DESCRIPTION OF THE SEVERAL VIEWS OF THE DRAWING

The invention will be better understood and objects other than those set forth above will become apparent when consideration is given to the subsequent detailed description thereof. Such description makes reference to the annexed Drawing denoting the following:
1 Fluid-filled container with opening 2 for piston rod 6. Alternatively, open container with movable frame.
1.1 Top view: Container 1 and buoy 5.
2 Elastic, sealed container opening.
3 Spring 4 fastened to container 1.
4 Spring: Installation depending upon type of spring (extension spring, compression spring, elastic spring tape, gas lifting bags.)
5 Buoy with piston rod 6 in container. Alternatively, buoy in movable frame.
6 Piston rod fastened to buoy 5.
7 Spring 4 fastened to buoy 5.
8 Locking bar 8 connected to container 1.
9 Locking bar 9 connected to reference system 10.
10 Reference system.
11 Container holder.
12 Steering mechanism at reference system 10.
13 Beam with joint 14.
14 Direction of movement 13.
15 Joint distance for return to start position.
16 Rope
17 Effective energy converter (spur gear—free wheel gear, transmission, gyrating mass, generator.)
18 Rope return spring.
19 Working stroke=Energy stroke. Here, piston rod stroke.
20 Drive shaft.
21 Solar-gear-motor or motor in general.
22 Wheel for the input of solar power at the container axle 25.
23 Spring
24 Toothed rack, spur wheel, free wheel on 25.
25 Container/rotation axle for input of external energy to rotate buoy/s 1.

### DETAILED DESCRIPTION OF THE INVENTION

While this invention is susceptible of embodiments in many different forms, there is shown in the Drawing and will be described in details herein one specific embodiment of the present invention, with the understanding that the present disclosure is to be considered as an example of the principles of the invention and is not intended to limit the invention to the embodiment illustrated and described. Also, it is to be understood that the phraseology and terminology employed herein are for the purpose of description and should not be regarded as limiting.

Two physics occurrences, (A) and (B), form the basis for the appended patent claims.

(A): When a buoy rises in a water-filled container, the buoy is held under water upon contact with the container lid. If, however, a spring connects the buoy with the container, the buoyancy force [N] extends the spring depending upon the selected spring characteristics (Hooke's Law). Thus, contact between the buoy and the container lid can be avoided. If a locking bar fastened the buoy to the container prior to the container's rotation, the buoyancy force [N] remains stored in the spring until the lock is released.
(B): A fluid-filled container placed on a scale contains a buoy that is submerged and fastened to the container. The weight of the container is F1 [N]. If the buoy detaches from the container and is, instead, kept submerged by a reference system located outside of the container, then, under ideal floating conditions (without touching the container and consideration of the buoy's dead load), the container's weight is F2 [N]:

F2 [N]=F1 [N] plus Weight [N].

The weight [N] is the fluid displaced by the buoy. Buoyancy force [N] and gravitational force [N] are equal in magnitude. The gravitational force [N] is determined by the buoyancy force [N] in accordance with the principle of “actio and reactio” (3. Newton Axiom.)

It is therefore suggested to initially store the buoyancy force [N] in springs so as to then add it to the gravitational force [N] to supply drive energy via a working stroke. This is possible when the buoy is kept in place by a connection to a reference system and the container, through releasing the connection to the buoy, is set in motion, which is caused by both the spring force and gravitational force [N].

With reference now to the Drawing, one possible embodiment is described in [0006]-[0015]:

The system in the Drawing is symmetrical. The container 1 contains water and one (or more) hydrodynamic buoy/s 5. The locking bar 8 can fasten the buoy 5 to the container 1. With the buoy's 5 rise (Drawing, left side) both springs 4 that are installed between buoy 5 and container 1 are extended (see 1.1, 3, 7.) If the container lid is not touched, the maximum buoyancy force [N] is stored in both springs 4 per [0004] (A). At that point, the buoy 5 is connected to the container 1 via the locking bar 8 and thus kept stationary within the container 1. The buoy's 5 piston rod 6, led through an elastic, sealed opening to the outside of the container 1, now maximally extends beyond the container 1 (Drawing, left side.)

If the inserted locking bar 9 fastens the buoy 5 to the reference system 10 and the lock 8 is released (Drawing, right side), the gravitational force [N] is exerted per [0004] (B). Additionally, the spring force [N] of the extension springs 4 shown in the Drawing pulls the container 1 toward the buoy 5 that is kept stationary within the reference system 10. This results in an addition of buoyancy force [N], stored in the springs 4, and gravitational force [N] until the container 1 (Drawing, right side) hits the buoy 5. A working stroke 19, also referred to as energy stroke 19 (work=energy), occurs due the motion of the carrying beam 13 around the rotation axle 14. The arising forces are energetically usable (Drawing), either directly (hydraulics, hydraulic accumulator, pneumatics, gas storage, lever, pumps, . . . ) or indirectly (rope 16, return spring 18, free wheel gear, transmission, gyrating mass, electrical generator, and combined 17.) As an alternate to the scheme shown in the Drawing, the reference system 10 and piston rod 6 can also function from above.

The Drawing shows the forces being translated into effective energy (Force×Distance) via the movable beam 13, 14 and connection to the energy converter 17, caused by the container holder's 11 respective lifting and lowering. In order to maximize the outwardly exerting buoyancy and gravitational forces [N], a steering mechanism 12 upholds the container holders' 11 vertical position during movement. The containers 1 are positioned to allow movement and connected by an expandable drive shaft 20. In the Drawing, all connections to the energy converter 17 are lead over a free wheel 14 because the effective forces of this system are generated one-sidedly. The return spring 18 keeps the rope 16 expanded. If the generated force per energy stroke is intended to increase and be supplied as the sum of available energy strokes, the installation of a “Nabe mit Achsen-Energiespeicher/Hub with Axle-Energy Storage” per DE 10 2005 047 629 A1 is recommended.

Upon completion of the described, single working stroke 19 the starting position shown in the Drawing needs to be reached in order to restart a force action. This occurs automatically after the piston rod 6 detaches from the reference system 10 (Drawing, right side) due to the joint distance 15. If necessary, the beam's 13 horizontal return may be guided by the steering mechanism 12. Once the containers 1 are turned semicircle through use of external energy, the locking bar 9 (Drawing, left side) can reconnect the piston rod 6 with the reference system 10. Release of the locking bar 8 initiates a new working stroke 19, this time on the left side of the Drawing. If, in extension of the Drawing, there are multiple containers placed slightly offset of one another, a proportionately smaller rotation is needed to reconnect a buoy 5 with the reference system 10. As shown in the Drawing, a solar-gear-motor 21 can support the rotation of the containers 1, which can be connected by the drive shaft 20, via the wheel 22. Alternatively, external energy can be used to move fluid or solid masses in or around the containers 1 in order to rotate the containers 1 and thus initiate a new working stroke 19.

During a working stroke, the drive loses potential energy through the piston rod stroke 19. Thus, the working container's 1 center of gravity distances itself from the rotation axle 25. Consequently, in addition to the friction losses, external energy is needed for the rotation of the containers 1 which affects the energy balance negatively. It is therefore recommended to optimize the buoyancy force [N] by adding light buoys 5, avoiding unnecessary contact between the buoys 5 and container 1, and installing wheel and axle and elastic container openings 2. An optimized energy balance is achieved when the height of the buoy 5 is greater than the piston rod stroke 19.

The energetically effective force is comprised of the constant gravitational force [N] and the decreasing spring force. Since the spring force is greatest at the onset of the energy stroke, it is also possible to store a portion of it in the spring 23 and use it through a toothed rack-spur wheel-free wheel combination 24 for a later rotation. With optimized execution, the use of external energy can be minimized. The Drawing depicts this solution for the left container only.

Other applications are possible, in which after a working stroke 19 the loss of potential energy is compensated by partial drainage of the water volume (minimize recurring flow of side water) in order to renew the supply after rotation around the rotation axle 25 to re-stretch the springs 4.

Or, after each energy stroke 19, measures are taken at the bottom of the buoy 5 that temporarily prevent the buoyancy according to [0001] (drain water; alter density ρ [kg/m³] with air; allow storage space for the water through pressure or vacuum) so that the buoy 5 drops down as a result of both its dead load and the above water head in order to again use the gravitational force [N] or bouncy force [N], this time without the containers' 1 rotation. During peaks of external energy, applications that also track the reference system, which is connected to the buoy 5 during the energy stroke, are possible; however this is energetically not favorably.

Preferably, in order to minimize the required external energy during the rotation, the center of gravity planes, as previously mentioned, should coincide with the rotation axle 25. This is to be achieved for the left side of the Drawing while the right side reveals a change of the center of gravity plane before and after lowering of the container 1 onto the buoy 5. An optimized shape of container 1 and buoy 5 as well as the interim use of the rising buoy's force 5 via a temporary shift of the water mass toward the container axle (not depicted in the Drawing) can influence the amount of required external energy. A container partially filled with water and several small buoys—instead of one large buoy 5—can have energetically positive results during rotation. Furthermore, the container 1 and buoy 5 can take different shapes than those shown in the Drawing. Open containers 1 require movable frames within the container 1 in which the buoys 5 can move when they are not fastened to the frame.

The selection of necessary system components depends upon the intended application. Required steering devices can be mechanical, electrical, magnetic, or manual in nature. The reference system 10 can also be placed within a—then modified—container 1. Automatic locking bars 8, 9 that easily disengage under load are to be installed with the appropriate stop collar. The length of the beam 13 can influence the working stroke on 16, 17, and 18.

A full circle rotation is possible in accordance with the described principle. The mounting of containers at the ends of the hub extensions, comparable to gondolas of a ferris wheel, require—analogous per the Drawing—rotation axles 25 in order to minimize the loss of potential energy when compared to a rigid connection. The buoy's connecting and detaching from the container or the framework would generate the working stroke. The rotation of said container can be supported with supply of external energy.

The invention “Drive Energy through Buoyancy-Gravitational Force ” can be a small scale installation or be applied in form of large scale technology. Potential external energy sources include solar electricity, wind power, water power (streams or tidal current), manual power, or fossil fuels. Tall buoys and shorter energy strokes are energetically favorably. The buoyancy medium can be used for thermal storage.

While one embodiment of the present invention has been illustrated in the accompanying Drawing and described hereinabove, it will be appreciated by those skilled in the art that various modifications, alternate constructions and equivalents may be employed without departing from the true spirit and scope of the invention. Therefore, the above description and the illustrations should not be construed as limiting the scope of the invention which is defined by the appended claims.

The invention claimed is:

1. Drive Energy through Buoyancy-Gravitational Force [N], characterized by
the buoyancy force [N] and gravitational force [N] of buoyant bodies, or buoys (5), in containers (1)
connecting and separating said buoys (5) to/from said assigned container (1),
linking said buoys (5) with an energy storage device, herein springs (4), to said assigned container (1),
and connecting and separating said buoys (5) to/from a stationary or movable reference system (10)
generate a working stroke (19) that supplies effective energy via a movable system (11, 13, 14, 15,)
the repetition of additional working stokes (19) occurs repeatedly following each of said containers' (1) rotation, and
the utilization of a portion of said supplied effective energy to rotate said containers (1) or, without rotating the containers (1), taking measures that, by temporarily suppressing the buoyancy force, said buoys (5) resume the starting position for a new working stroke (19) within a movable system to achieve the use of the gravitational force [N] or the buoyancy force [N].

2. Drive Energy through Buoyancy-Gravitational Force [N], the combination as claimed in claim 1, wherein
a movable system is comprised of one or more containers (1),
the container/s (1) contain a buoy/s (5) and buoyancy mediums, for example frost-free water,
buoyancy force [N] of the buoy (5) is exerted on the container (1) with or without an energy storage device, herein springs (4),
a part of the buoyancy force [N] and the gravitational force [N] can be used as steering energy, also through periodic shifts of movable masses,
the buoyancy force [N] can be stored in springs (4),
by attaching the buoy/s to an external reference system (10) or a reference system within the container (1), the gravitational force [N] of the buoys (5) can exert within the container (1) by releasing the connection to the container (1),
now, in addition, the buoyancy force stored in the spring force can exert between the buoys (5), which are fastened to the reference system (10), and the container (1),
under load easily disengaging and fastening locking bars (8, 9) are installed, thereby the assembled motion system can supply energy,
the motion system resumes the starting position by temporarily using the buoyancy force [N], gravitational force [N], and external energy (21, 22) via the container axle (25),
the rotation of the containers (1) can be avoided when, through temporary suppression of the buoyancy, a new starting position occurs to facilitate another energy stroke.

3. Drive Energy through Buoyancy-Gravitational Force [N], the combination as claimed in claim 1 and claim 2, wherein
the connection and release of the reference system (10) to/from the buoys (5) is accomplished with mechanical, electrical, magnetic or manual components, or combinations thereof, and a multivalent drive system is created through the introduction of additional external forces that leverage movement.
